(19) United States
(12) Patent Application Publication
(10) Pub. No.: US 2026/0365015 A1
(43) Pub. Date: Nov. 19, 2026

(54) Off-Road Vehicle And Drive Mode Switching Thereof

(71) Applicant: Zhejiang CFMOTO Power Co., Ltd., Hangzhou (CN)

(72) Inventors: Xiaoxuan Ji, Hangzhou (CN); Baiyang Wang, Hangzhou (CN); Yaohui Yang, Hangzhou (CN); Jiahui Li, Hangzhou (CN)

(21) Appl. No.: 19/679,895

(22) Filed: May 18, 2026

(30) Foreign Application Priority Data
May 19, 2025 (CN) 202510653067.3

(51) Int. Cl. B60K 35/10

(52) U.S. Cl. CPC B60K 35/10; B60K 2360/126; B60K 2360/42

(57) ABSTRACT

An electrical system for an off-road vehicle includes a control module and a knob switch unit for switch drive modes of the off-road vehicle in response to a driver's rotation operation. A knob is capable of rotating multiple revolutions relative to a mounting base, and at least part of a mode switching circuit is positioned between the knob and the mounting base. The mode switching circuit comprises at least one conductive terminal positioned on the knob, a circuit board positioned on the mounting base, and at least one conductive tab positioned on the circuit board facing the conductive terminal. Completion of an electrical circuit through the conductive terminal and the conductive tab is used by the control module in controlling the off-road vehicle to switch drive mode. This structure and method can achieve accurate multi-mode switching of off-road vehicle at low cost.

### RELATED APPLICATION INFORMATION

The present application claims priority to Chinese patent application No. 202510653067.3, filed on May 19, 2025, the entire contents of which are incorporated herein by reference.

### FIELD OF THE DISCLOSURE

The present invention relates to the field of operation and control of off-road vehicles, and in particular to an off-road vehicle having multiple drive modes.

### BACKGROUND OF THE DISCLOSURE

As a vehicle capable of driving on various complex terrains, the switching of drive modes for off-road vehicles is crucial for adapting to different driving conditions. Switching drive modes for off-road vehicles may be by the following methods. One of the methods is to achieve mode switching through a single button or dual buttons. This method is relatively easy to operate when the number of modes is small, but as the number of modes increases, the convenience and accuracy of operation will significantly decrease. Another method is to use Hall sensors as mode switching knobs. Although this method can achieve multi-mode switching, its cost is high, and in harsh outdoor environments, the waterproof and shockproof performance of Hall sensors often fails to meet the needs of off-road vehicles.

In addition, there are certain limitations in the structural design of the related knob devices. For example, some knob devices can only achieve single turn rotation, which limits the flexibility and accuracy of drive mode switching. Some knob devices have complex circuit designs, which not only increase manufacturing costs but also reduce system reliability.

### SUMMARY OF THE INVENTION

In order to address the shortcomings of existing technology, the purpose of the present invention is to provide a low-cost off-road vehicle that achieves precise switching between different driving modes.

To achieve the above objectives, the present invention adopts the following technical solution.

An off-road vehicle includes a plurality of wheels, a prime mover assembly, and an electrical system. The prime mover assembly is capable of outputting torque for the plurality of wheels to move the off-road vehicle. The electrical system is at least used to control the prime mover assembly, and the electrical system includes a control module and a knob switch unit. The knob switch unit is configured to send control signals to the control module in response to a driver's rotation operation. The control module is capable of switching drive mode of the off-road vehicle based on the control signals. The knob switch unit includes a knob, a mounting base, and a mode switching circuit. The knob is capable of rotating multiple revolutions relative to the mounting base about its own rotational axis. At least part of the mode switching circuit is positioned between the knob and the mounting base. The mode switching circuit comprises at least one conductive terminal positioned on the knob, a circuit board positioned on the mounting base, and at least one conductive tab positioned on the side of the circuit board facing the conductive terminal. When the knob is rotated, the conductive terminal is rotated relative to the conductive tab. Completion of an electrical circuit through the conductive terminal and the conductive tab is used by the control module in controlling the off-road vehicle to switch drive mode.

The invention includes both the off-road vehicle structure and method for performing drive mode switching in the off-road vehicle. This structure and method can achieve accurate multi-mode switching of the off-road vehicle at low cost.

### BRIEF DESCRIPTION OF THE DRAWINGS

FIG. 1 shows a perspective view of an off-road vehicle according to a preferred embodiment of the present invention;

FIG. 2 is a side view of a knob switch unit for switching drive modes in the off-road vehicle of FIG. 1;

FIG. 3 is a perspective view of the underside/interior of the knob in the knob switch unit of FIG. 2;

FIG. 4 is a perspective view of the mounting base in the knob switch unit of FIG. 2 after the knob has been removed;

FIG. 5 is a front view of the circuit board of FIG. 4, annotated with dashed lines to show the different regions of electrical circuit;

FIG. 6 is a front view of the circuit board of FIG. 4;

FIG. 7 is a rear view of the circuit board of FIG. 4, also showing the interior traces in the circuit board;

FIG. 8 is a schematic diagram of the pins and the first and second connection points in the circuit board of FIGS. 5-7 and control module of FIG. 2; and

FIG. 9 is a flowchart of alternative control logic in the control module of FIGS. 2 and 8.

### DETAIL DESCRIPTION

In order to make the purpose, technical solution, and advantages of this invention clearer and more understandable, the following will provide further detailed explanations of this invention in conjunction with the accompanying drawings and embodiments. It should be noted that the specific embodiments described herein are only used to explain the present invention and are not intended to limit coverage of this patent.

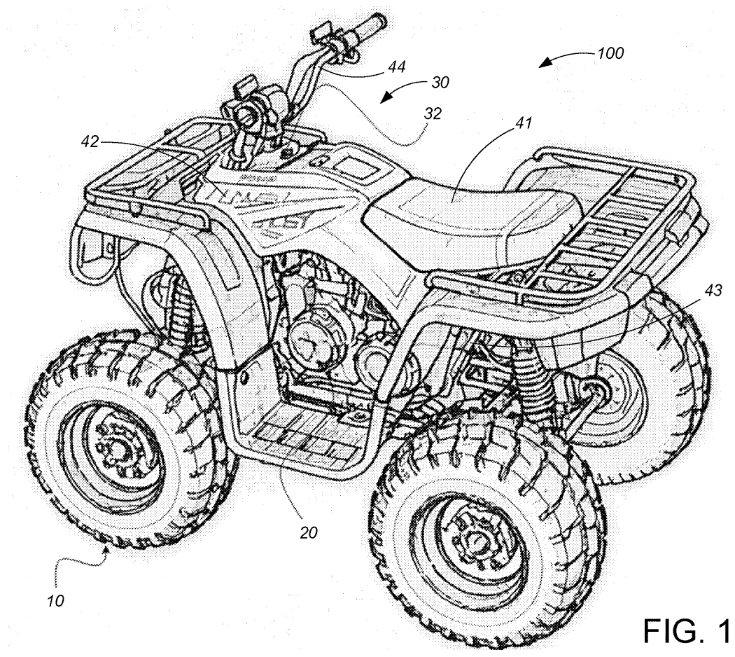

The present invention involves an off-road vehicle 100 such as the all-terrain vehicle (ATV) shown in FIG. 1, although the invention can also be applied to other off-road vehicles such as utility vehicles (not shown) and side-by-sides (not shown). The ATV 100 includes a plurality of wheels 10, a prime mover assembly 20, and an electrical system 30. The plurality of wheels 10 preferably includes two or more preferably four wheels which are driven to cause the off-road vehicle 100 to travel and convert torque into movement of the off-road vehicle 100. The prime mover assembly 20 is responsible for generating torque, which is transmitted to the plurality of wheels 10 to drive the off-road vehicle 100 forward or backward.

The electrical system 30 includes at least a control module 31 (shown in FIG. 8) and a knob switch unit 32. The knob switch unit 32 is mounted so as to be hand accessible to the driver of the vehicle 100 while seated on a driver's seat 41. The knob switch unit 32 is configured to send control signals to the control module 31 in response to a driver's rotational hand manipulation of a knob 321 of the knob switch unit 32. The control module 31 mounted on the vehicle 100, preferably in a protected position such as under a vehicle cover 42. The control module 31 is capable of switching a drive mode of the off-road vehicle 100 based on the control signals received from the knob switch unit 32.

The ATV 100 includes at least two drive modes, and more preferably includes three to six drive modes. In the preferred embodiment, the drive modes include modes of “Normal” mode, “Sports” mode, and “Race Track” mode. Normal mode is suitable for daily driving, Sport mode is suitable for driving scenes requiring higher power output, and Race Track mode is suitable for track driving and provides the strongest power output. Other embodiments utilize other drive modes of the off-road vehicle 100. When switching between drive modes, the control module 31 either directly changes or causes changing of one or more of the following vehicle parameters: a) throttle mapping; b) accelerator pedal response; c) ignition timing response and control; d) throttle valve response and control; e) engine braking; f) turbocharger control and response; g) shock absorber or other suspension settings; h) steering wheel control and feedback; i) 2-wheel, 4-wheel, or differential locking settings; j) gear change points; k) speed limit settings; l) VVT (variable valve timing) settings and control; m) VVL (variable valve lift) settings and control; n) dual injection settings and control; o) coolant fan settings and control; p) thermostat settings and control; q) intercooler fan settings and control; r) exhaust silencer valve settings and control; and s) fuel injection settings and control.

The control module 31 preferably includes a micro-controller or micro-processor (not independently shown) and other electronic components (not independently shown) on a control module circuit board (not independently shown). For example, the control module 31 may include a high-performance ARM Cortex-M series micro-controller for receiving control signals from the knob switch unit 32.

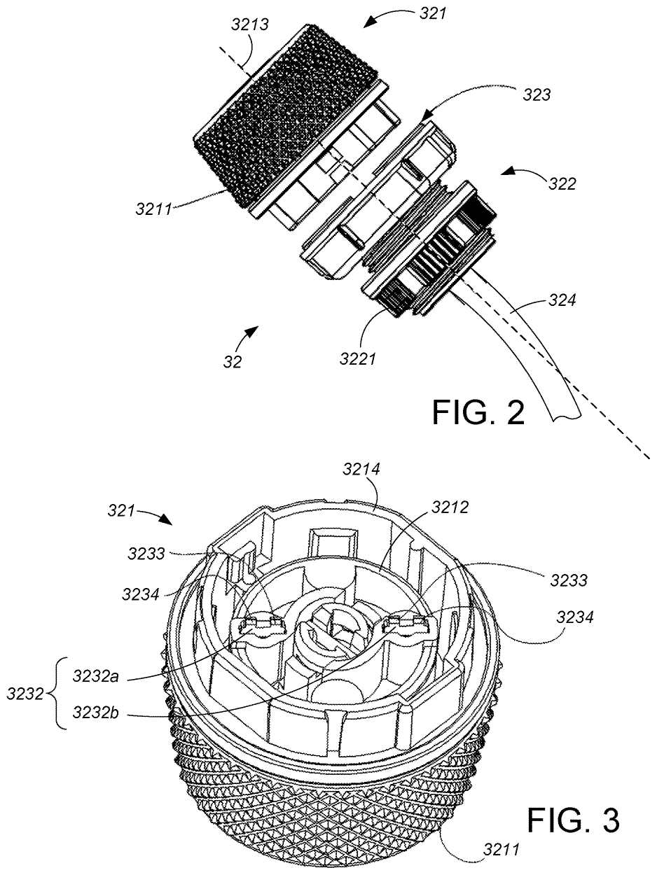

The knob switch unit 32 by itself is shown in FIG. 2. In addition to the knob 321, the knob switch unit 32 includes a mounting base 322 and an internal mode switching circuit 323. The knob 321 has a knob exterior 3211 and preferably also a knob hub 3212 which are rotationally mounted for rotation around a knob rotational axis 3213 relative to a knob seat 3214. For instance, the knob exterior 3211 may be knurled or otherwise textured or shaped for easy grasping control and rotation by the driver. The knob seat 3214 preferably snaps in to the mounting base 322, such that the knob exterior 3211 and knob hub 3212 are capable of rotating multiple revolutions relative to the mounting base 322.

The mounting base 322 includes a mounting base nut 3221 for fixedly securing the mounting base 322 to the vehicle cover 42, vehicle frame 43, handlebars 44 or other portion of the vehicle 100, such that the mounting base 322 provides support and positioning for the knob 321. The mounting base 322 also preferably provides support and positioning for a circuit board 3231 of the mode switching circuit 323.

The mode switching circuit 323 is generally located at the interface between the knob 321 and the mounting base 322. The mode switching circuit 323 includes at least one and more preferably a plurality of conductive terminals 3232 secured to the knob hub 3212 internal to the knob exterior 3211 and facing toward the mounting base 322, such that the conductive terminals 323 make sliding contact with the circuit board 3231 located on the mounting base 322. The conductive terminals 3232 are formed of an electrically conductive metal such as copper, aluminum or brass, while the knob hub 3212 and the knob exterior 3211 are formed of a dielectric material, such as being molded of polymer with the conductive terminals 3232 positioned as inserts into the mold. The preferred mode switching circuit 323 includes two conductive terminals 3232, each having an inner sliding prong 3233 and an outer sliding prong 3234. The two conductive terminals 3232 preferably have the same structure, mounted 1800 offset about the knob rotational axis 3213.

The circuit board 3231 includes at least one conductive tab 3235 located on the side of the circuit board 3231 facing the conductive terminal(s) 3232, with the preferred circuit board 3231 having one inner tab 3235a and four outer tabs 3235b, 3235c, 3235d, 3235e. Alternative embodiments use a single outer tab and multiple inner tabs, and/or different numbers of inner/outer tabs rather than one/four. The conductive tabs 3235 are formed of an electrically conductive metal such as copper, while the circuit board 3231 is formed of a dielectric material such as fiberglass. The inner tab 3235a is preferably annular, simplifying circuit design, while each of the four outer tabs 3235b, 3235c, 3235d, 3235e is preferably a circular arc. The conductive terminals 3232 are positioned at a radius from the knob rotational axis 3213 such that the inner sliding prong 3233 of each conductive terminal 3232 makes contact with the inner conductive tab 3235a regardless of rotational position of the knob 321, i.e., throughout 360° or more rotation of the knob 321. The outer sliding prong 3234 of each conductive terminal 3232 is at a radius relative to the rotational axis 3213 to make contact with one of four outer tabs 3235b, 3235c, 3235d, 3235e depending upon rotational position of the knob 321. Control signals are generated based upon the rotational position and action of the knob 321, specifically, based upon whether (and possibly which) outer tabs 3235b, 3235c, 3235d, 3235e are used to complete an electrical circuit through one of the conductive terminals 3232 and the inner tab 3235a. As the driver rotates the knob 321, different patterns of contact are made between the four outer tabs 3235b, 3235c, 3235d, 3235e and the two conductive terminals 3232. The control signals are transmitted to the control module 31, preferably to achieve the switching of drive modes.

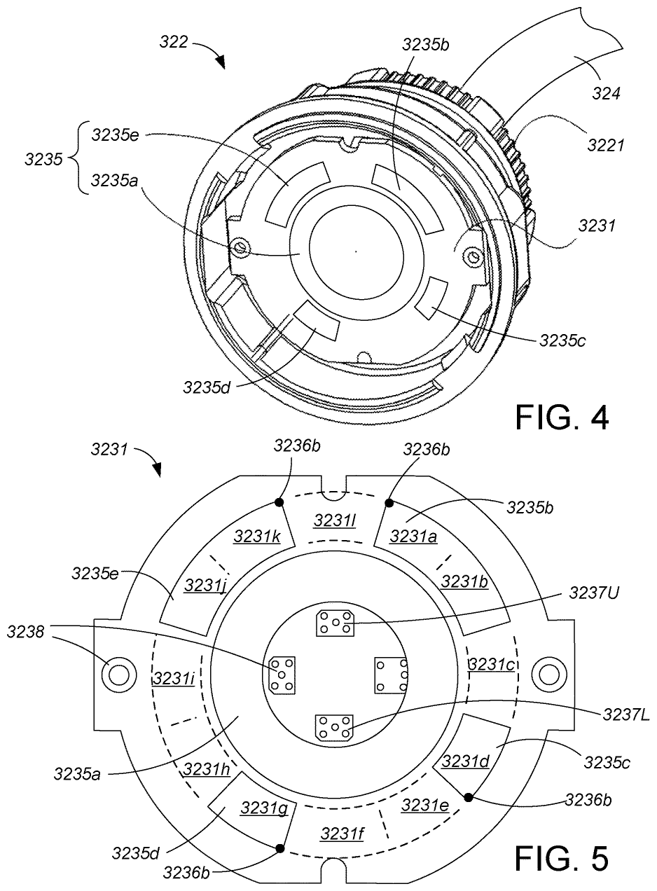

FIGS. 4-6 show the front side of the preferred circuit board 3231 facing the knob 321, and FIG. 7 shows the opposing back side of the preferred circuit board 3231. As shown in FIGS. 4-6, two upper outer tabs 3235e, 3235b preferably each extend over about 60° of knob rotation separated by about 30° gaps, while two lower outer tabs 3235c, 3235d, preferably each extend over about 30° of knob rotation separated by about 60° gaps. The terms “upper” and “lower” as used herein merely refer to the orientation of the circuit board 3231 shown in the drawings (and not in reference to elevation on the vehicle 100), which can be arbitrarily oriented during mounting without affecting operation of the invention. With the preferred different circumferential lengths and positioning of the outer tabs 3235b, 3235c, 3235d, 3235e, a complete revolution (360° rotation) of the knob 321 is thus conceptually separated into twelve 300 regions which can be labeled 3231a-3231l as shown in FIG. 5. The preferred knob 321 includes detents (not shown) so the knob 321 can “click” into position at a center location in each of these twelve different positions 3231a-3231l. The selection of twelve, rather than a different number, of separate regions 3231a-3231l is selected based on weighing several factors, including a) product experience input, b) the number of driving modes, and c) circuit signal recognition. Based on actual experience with rotating knob inputs, twelve positions 3231a-3231l spaced at 30° offers good convenience and hand feeling. The number of driving modes is typically two to six, and more preferably three or four; to maximize the functional applicability of the knob switch unit 32, the number of positions should be a multiple of 2, 3, 4, 5 and 6, and more preferably a multiple of 3 or 4. Additionally, after the amount of torque required for rotating of the knob 321 is pre-set, according to actual manual rotating speed of the knob 321 and collected internal circuit signals, the number of positions 3231a-3231l cannot be too large; otherwise, the signals cannot be effectively identified. Other embodiments can use different circumferential lengths and positioning to create more or less than twelve regions.

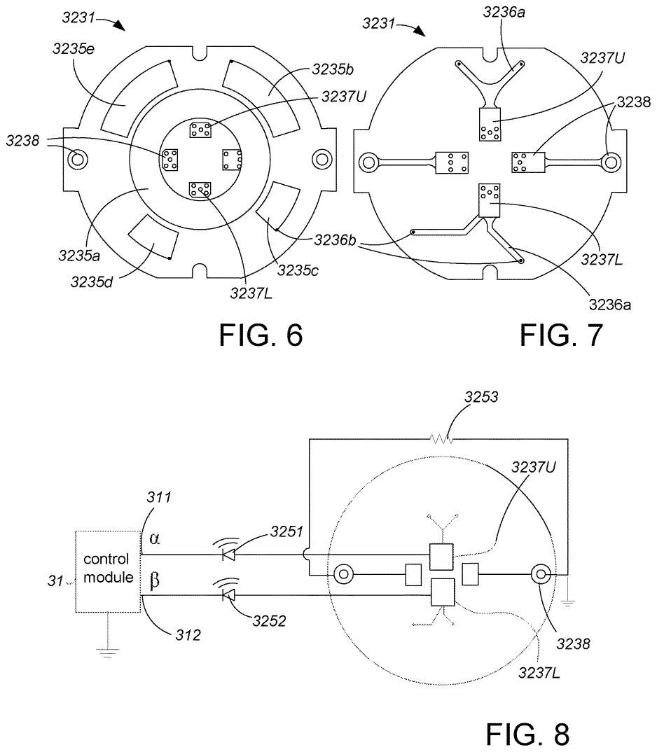

Because only three drive modes (Normal, Sport and Race Track) are used, the preferred embodiment adds traces 3236a inside the circuit board 3231 as shown in FIG. 7 and through hole vias 3236b as shown in FIGS. 6 and 7. The traces 3236a and through hole vias 3236b electrically couple the two upper outer tabs 3235e, 3235b into an upper pad 3237U and couple the two lower outer tabs 3235c, 3235d into a lower pad 3237L, with both pads 3237U, 3237L exposed on a back side of the circuit board 3231 for soldering point electrical connection using a cable or wiring harness 324 to the control module 31. The control module 31 can be programmed to sense either voltage or current flow to determine if an electrical circuit has been completed.

The signals on the two pads 3237U, 3237L are assessed by the control module 31 primarily to determine amount and (possibly direction of) rotation of the knob 321 in 30° increments. With only three different drive modes being selected (and with no distinction electrically being made as to which of the two conductive terminals 3232 is in circuit), the signals on the two pads 3237U, 3237L repeat for each 90° of knob rotation, with only a maximum of only 60° of rotation to change between the three drive mode outputs. Other embodiments that have more than three different drive modes could instead use additional pads, such as a separate pad for each of the four outer tabs, and/or including more than four outer tabs, and/or by distinguishing electrically as to which of the two conductive terminals 3232 is transmitting electricity. With only three different drive modes being selected, the signals are identical whether the connection is made through the first conductive terminal 3232a or through the second conductive terminal 3232b. Other embodiments could distinguish between which conductive terminal 3232a or 3232b is completing the signal, such as by adding a resistor (not shown) in series between the two prongs 3233, 3234 of one of the conductive terminals 3232a or 3232b so as to produce a different voltage or current output. Other embodiments could also utilize more or less than 30° increments, such as fifteen 24° increments per 360° rotation or nine 40° increments per 360° rotation or eight 45° increments per 360° rotation.

As the driver rotates the knob 321 through the twelve regions 3231a-3231l of the preferred embodiment, the two conductive terminals 3232 are sequentially in contact with the different outer tabs 3235b, 3235c, 3235d, 3235e as follows:

| First Terminal | First terminal 3232a | Second terminal 3232b |
|---|---|---|
| (3232a) | completes circuit | completes circuit |
| in this Region | (tab/pad)? | (tab/pad)? |
| 3231a | Y-3235b/3237U | Y-3235d/3237L |
| 3231b | Y-3235b/3237U | N |
| 3231c | N | N |
| 3231d | Y-3235c/3237L | Y-3235e/3237U |
| 3231e | N | Y-3235e/3237U |
| 3231f | N | N |
| 3231g | Y-3235d/3237L | Y-3235b/3237U |
| 3231h | N | Y -3235b/3237U |
| 3231i | N | N |
| 3231j | Y-3235e/3237U | Y-3235c/3237L |
| 3231k | Y-3235e/3237U | N |
| 3231l | N | N |

Because these various positions are only assessed on the two pads 3237U, 3237L and used to select between only three (Normal, Sport and Race Track) drive modes, the preferred control module 31 merely senses whether an electrical circuit has been completed at the Upper and Lower pads 3237U, 3237L.

In the preferred control module 31 as shown in FIG. 7, the control module 31 includes an α-pin 311 electrically connected to the upper pad 3237U and a β-pin 312 electrically connected to the lower pad 3237L. The voltage and/or current signal on the α-pin 311 and the β-pin 312 are used to select drive mode in the vehicle 100.

In one preferred embodiment, the selection of drive mode simply corresponds to the number of pads/pins connected in a completed electrical circuit. If zero electrical circuits are completed (i.e., if the driver rotates the knob 321 so the terminals 3232 are in the 3231c, 3231f, 3231i or 3231l regions), then the control module 31 switches the vehicle 100 into Normal mode. If one electrical circuit is completed (i.e., if the driver rotates the knob 321 so the terminals 3232 are in the 3231b, 3231e, 3231 h or 3231k regions), then the control module 31 switches the vehicle 100 into Race Track mode. If two electrical circuits are completed (i.e., if the driver rotates the knob 321 so the terminals 3232 are in the 3231a, 3231d, 3231g or 3231j regions), then the control module 31 switches the vehicle 100 into Sport mode. In other words, when the knob 321 is rotated clockwise, the drive modes are cyclically switched in sequence in a loop as follows: Normal, then Sport, then Race Track, then starting again at Normal, etc. repeatedly. When the knob 321 is rotated counterclockwise, the drive modes are cyclically switched in sequence in a loop as follows: Normal, then Race Track, then Sport, then starting again at Normal, etc. repeatedly.

In another embodiment, the control module 31 reviews the changing number of completed electrical circuits to determine clockwise/counter-clockwise direction of rotation of the knob 321 relative to the current drive mode. If the number of pads/pins connected in a completed electrical circuit changes from zero to one, from one to two, or from two to zero, then the driver is rotating the knob 321 counter-clockwise one position. If the number of pads/pins connected in a completed electrical circuit changes from zero to two, from two to one, or from one to zero, then the driver is rotating the knob 321 clockwise one position. When the knob 321 is rotated clockwise, the drive mode of the off-road vehicle 100 is switched from Normal to Sport and then with further clockwise rotation to Race Track. After reaching Race Track mode, further clockwise rotation of the knob 321 does not cycle the drive mode of off-road vehicle 100 back to Normal or Sport; instead further clockwise rotation causes no change in drive mode. When knob 321 is rotated counter-clockwise, the drive mode of off-road vehicle 100 can be switched from Rack Track to Sport and then with further counter-clockwise rotation to Normal. After reaching Normal mode, further counter-clockwise rotation of the knob 321 does not cycle the drive mode of off-road vehicle 100 back to Race Track or Sport; instead further counter-clockwise rotation causes no change in drive mode. In this embodiment, sequencing of drive mode is thus unidirectional depending upon the clockwise/counter-clockwise direction of rotation of the knob 321. Once the third mode is reached when rotating in that direction, the drive mode will not be further changed if the driver continues rotation in the same direction. In this unidirectional sequencing embodiment, the design ensures the stability and predictability of drive modes, allowing users to choose between different drive modes according to their own driving needs without worrying about unexpected mode cycling. Alternative but similar unidirectional sequencing embodiments can be provided if the off-road vehicle has four, five or six drive modes.

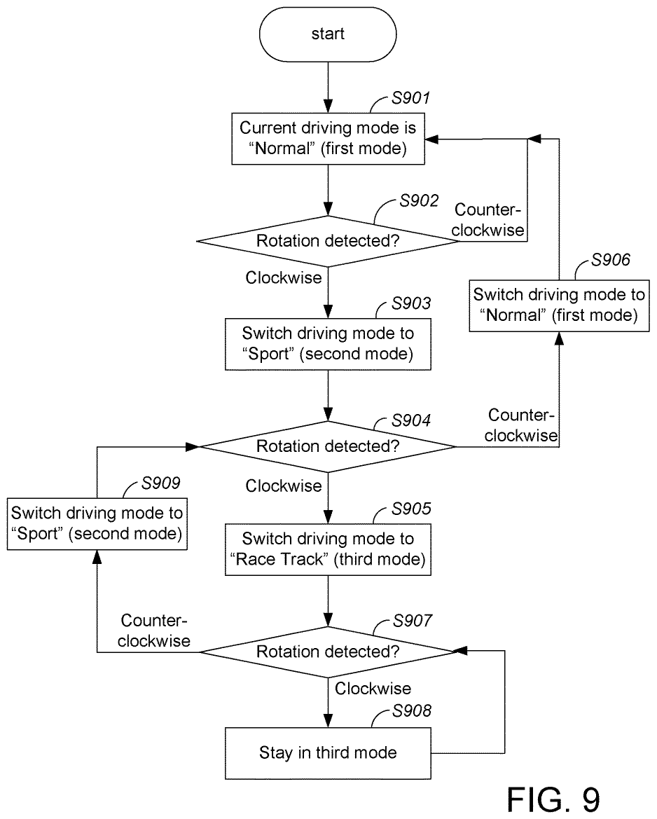

FIG. 9 shows a logic flowchart for such a unidirectional sequencing embodiment. The switching steps of drive mode for off-road vehicle 100 are as follows.

In step S901, initially (such as whenever the prime mover assembly 20 is started) the current drive mode is Normal, regardless of rotational position of the knob 321.

In step S902, the control module 31 looks for a signal change on either the α-pin 311 or the β-pin 312 to determine whether the knob 321 is rotated. As soon as a signal change occurs indicating a one-position rotation of the knob 321, the control module 31 determines the direction of rotation as explained above (i.e., number of completed circuits changing from zero to two, from two to one, or from one to zero indicates clockwise; number of completed circuits changing from zero to one, from one to two, or from two to zero indicates counter-clockwise). If the knob 321 is rotated clockwise, the control logic in the control module 31 proceeds to step S903. If the knob 321 rotated counterclockwise, then the control module 31 retains the vehicle 100 in Normal drive mode and the control logic returns to step S901.

In step S903, the control module 31 switches the drive mode to Sport (the second mode after starting), and proceeds to step S904.

In step S904, the control module 31 determines whether the knob 321 is rotated, and the direction of rotation. If the knob 321 is rotated clockwise, the control logic in the control module 31 proceeds to step S905. If the knob 321 is rotated counterclockwise, the control logic in the control module 31 proceeds to step S906.

In step S905, the control module 31 switches the drive mode to Race Track (the third mode after starting), and proceeds to step S907.

In step S906, the control module 31 switches the drive mode to Normal, and the control logic returns to step S901.

In step S907, the control module 31 determines whether the knob 321 is rotated, and the direction of rotation. If the knob 321 is rotated clockwise, then the control module 31 retains the vehicle 100 in Race Track (third) drive mode as step S908 and the control logic returns to step S907. If the knob 321 is rotated counterclockwise, then the control logic in the control module 31 proceeds to step S909.

In step S909, the control module 31 switches the drive mode to Sport (second) drive mode, and the control logic returns to step S904.

Similar control logic can be employed if the number of drive modes for the vehicle is two, four, five or six.

The preferred structure and method can achieve accurate and uniform multi-mode switching of off-road vehicle 100 at low cost, with a simple structure and high circuit stability and reliability. When the knob 321 is rotated by a set (in the preferred embodiment, 30°) angle, the conductive terminals 3232 trigger different mode selection regions to perform drive mode selection.

If desired, electricity through the completed circuit can be used supply power to weak current devices. For example, if one pad/pin is connected in a completed electrical circuit, then electricity in that completed circuit can be used to light a light emitting diode (LED) 3251 in series indicating that the vehicle 100 is in Race Track mode. If two pads/pins are connected in a completed electrical circuit, then electricity in those completed circuits can be used to light a different (second) light emitting diode (LED) 3252 and/or to have the first LED emit a different color of light, indicating that the vehicle 100 is in Sport mode. In the same vein, if no pads/pins are connected in a completed electrical circuit, then electricity from the inner tab 3235a can be routed through a negative pole 3238 on the circuit board 3231 to light up a background light 3253 of the knob switch unit 32. In another embodiment (not shown), electricity from the inner tab 3235a can be routed through the negative pole to light up the background light 3253 on its way to ground, regardless of the number of other completed electrical circuits. Workers skilled in the art will realize there are numerous equivalent ways to achieve lighting circuits as desired based on operation and electricity in the knob switch unit 32. Workers skilled in the art will also recognize that all lighting can be omitted without affecting performance of the drive mode switching structure and method.

The above embodiments only express several embodiments of the present invention, and their descriptions are more specific and detailed, but should not be understood as limiting the scope of the present patent. For ordinary technical personnel in this field, several modifications and improvements can be made without departing from the concept of this invention, which are within the scope of protection. Therefore, the scope of protection of this invention should be based on the attached claims.

1. An off-road vehicle comprising:
a plurality of wheels;
a prime mover assembly capable of outputting torque for the plurality of wheels to move the off-road vehicle; and
an electrical system at least used for controlling the prime mover assembly;
wherein the electrical system comprises:
a control module; and
a knob switch unit configured to send control signals to the control module in response to a driver's rotation operation, the control module being capable of switching drive mode of the off-road vehicle based on the control signals; the knob switch unit comprising a knob, a mounting base, and a mode switching circuit, the knob being capable of rotating multiple revolutions relative to the mounting base about its own rotational axis, at least part of the mode switching circuit being positioned between the knob and the mounting base;
wherein the mode switching circuit comprises at least one conductive terminal positioned on the knob, a circuit board positioned on the mounting base, and at least one conductive tab positioned on the circuit board facing the conductive terminal, such that when the knob is rotated, the conductive terminal is rotated relative to the conductive tab, and wherein completion of an electrical circuit through the conductive terminal and the conductive tab is used by the control module in controlling the off-road vehicle to switch drive mode.

2. The off-road vehicle of claim 1, wherein the at least one conductive tab comprises an inner conductive tab and an outer conductive tab, wherein the conductive terminal completes the electrical circuit only in certain rotational positions of the knob.

3. The off-road vehicle of claim 2, wherein one of the inner conductive tab and the outer conductive tab is annular about the rotational axis of the knob, making sliding contact with the conductive terminal in all rotational positions of the knob.

4. The off-road vehicle of claim 1, wherein the mode switching circuit comprises a second conductive terminal positioned on the knob, wherein the control module switches drive mode based upon a number of electrical circuits completed.

5. The off-road vehicle of claim 1, wherein the mode switching circuit comprises a second conductive terminal positioned on the knob, wherein the control module switches drive mode based upon a direction of knob rotation determined from a change in number of electrical circuits completed.

6. The off-road vehicle of claim 1, wherein the knob can be rotated more than a complete revolution in either rotational direction.

7. The off-road vehicle of claim 6, wherein a 360° rotation of the knob causes the control module to cycle through drive modes more than once.

8. The off-road vehicle of claim 6, wherein the mode switching circuit comprises a second conductive terminal positioned on the knob, wherein the control module switches drive mode based upon a direction of knob rotation determined from a change in number of electrical circuits completed, wherein a rotation of the knob of less than 360° in one rotational direction can cause the control module to cycle through all drive modes, and additional rotation of the knob in that one rotational direction does not causes the control module to further change drive modes.

9. The off-road vehicle of claim 1, wherein the mode switching circuit comprises a plurality of conductive tabs, wherein the control module switches drive mode based upon a direction of knob rotation determined from a change in number of electrical circuits completed.

10. The off-road vehicle of claim 1, wherein the at least one conductive tab comprises a first conductive tab and a second conductive tab, wherein the at least one conductive terminal makes sliding contact with the first conductive tab for less than a 360° rotation of the knob, and wherein the at least one conductive terminal makes sliding contact with the second conductive tab for less than a 360° rotation of the knob.

11. The off-road vehicle of claim 10, wherein the first conductive tab occupies a first circular arc about the rotational axis of the knob, wherein the second conductive tab occupies a second circular arc about the rotational axis of the knob, and wherein the first circular arc and the second circular arc have different circumferential lengths.

12. The off-road vehicle of claim 10, wherein the first conductive tab extends for 60° about the rotational axis of the knob, wherein the second conductive tab extends for 30° about the rotational axis of the knob, and further comprising a third conductive tab extending for 30° about the rotational axis of the knob and a fourth conductive tab extending for 60° about the rotational axis of the knob.

13. The off-road vehicle of claim 12, wherein the mode switching circuit comprises a second conductive terminal positioned on the knob.

14. The off-road vehicle of claim 13, wherein the control module switches drive mode based upon a number of electrical circuits completed.

15. The off-road vehicle of claim 13, wherein the control module switches drive mode based upon a direction of knob rotation determined from a change in number of electrical circuits completed.

16. The off-road vehicle of claim 1, wherein knob rotation of 30° causes the control module to switch the off-road vehicle from a first drive mode to a second drive mode, wherein additional knob rotation of 30° causes the control module to switch the off-road vehicle from a second drive mode to a third drive mode.

17. The off-road vehicle of claim 1, wherein electricity through the completed electrical circuit through the conductive terminal and the conductive tab is used for lighting.

18. The off-road vehicle of claim 1, wherein when switching between drive modes, the control module either directly changes or causes changing of one or more of the following vehicle parameters: a) throttle mapping; b) accelerator pedal response; c) ignition timing response and control; d) throttle valve response and control; e) engine braking; f) turbocharger control and response; g) shock absorber or other suspension settings; h) steering wheel control and feedback; i) 2-wheel, 4-wheel, or differential locking settings; j) gear change points; k) speed limit settings; l) VVT (variable valve timing) settings and control; m) VVL (variable valve lift) settings and control; n) dual injection settings and control; o) coolant fan settings and control; p) thermostat settings and control; q) intercooler fan settings and control; r) exhaust silencer valve settings and control; and s) fuel injection settings and control.

19. A method of switching drive mode of an off-road vehicle, the off-road vehicle comprising:
a plurality of wheels;
a prime mover assembly capable of outputting torque for the plurality of wheels to move the off-road vehicle; and
an electrical system at least used for controlling the prime mover assembly;
wherein the electrical system comprises:
a control module; and
a knob switch unit configured to send control signals to the control module in response to a driver's rotation operation, the control module being capable of switching drive mode of the off-road vehicle based on the control signals; the knob switch unit comprising a knob, a mounting base, and a mode switching circuit, the knob being capable of rotating multiple revolutions relative to the mounting base about its own rotational axis, at least part of the mode switching circuit being positioned between the knob and the mounting base;
wherein the mode switching circuit comprises at least one conductive terminal positioned on the knob, a circuit board positioned on the mounting base, and at least one conductive tab positioned on the circuit board facing the conductive terminal, such that when the knob is rotated, the conductive terminal is rotated relative to the conductive tab;
the method of switching drive mode of an off-road vehicle comprising:
determining in the control module whether an electrical circuit through the conductive terminal and the conductive tab can been completed; and
having the control module use the determination of electrical circuit completion in controlling the off-road vehicle to switch drive mode.

20. The method of claim 19, wherein the control module switches drive mode based upon a direction of knob rotation determined from a change in number of electrical circuits completed.
